(19) United States
(12) Patent Application Publication
(10) Pub. No.: US 2015/0188324 A1
(43) Pub. Date: Jul. 2, 2015

(54) SYSTEMS AND METHODS TO INCREASE AND DECREASE CHARGING CURRENT TO BATTERY

(71) Applicant: LENOVO (SINGAPORE) PTE. LTD., New Tech Park (SG)

(72) Inventors: John Weldon Nicholson, Cary, NC (US); Axel Ramirez Flores, Cary, NC (US); Howard Jeffrey Locker, Cary, NC (US); Scott Edwards Kelso, Cary, NC (US); John Miles Hunt, Raleigh, NC (US); Kenneth Scott Seethaler, Wake Forest, NC (US); Larry Glenn Estes, Durham, NC (US); Jeremy Robert Carlson, Cary, NC (US)

(73) Assignee: LENOVO (SINGAPORE) PTE. LTD., New Tech Park (SG)

(21) Appl. No.: 14/143,429

(22) Filed: Dec. 30, 2013

(51) Int. Cl. H02J 7/00

(52) U.S. Cl. CPC H02J 7/007

(57) ABSTRACT

In one aspect, a device includes a battery charger, a processor, and a memory accessible to the processor. The memory bears instructions executable by the processor to access a history of at least one previous battery charge by the battery charger of a battery powering the device, access calendar information of a user of the device, determine an approximate time available to charge the battery based on the history, the calendar information, and a current charge level of a battery to be charged by the battery charger, and regulate current from the battery charger to the battery to charge the battery to a predetermined capacity to within at least a threshold time of the approximate time available.

### I. FIELD

The present application relates generally to charging batteries.

### II. BACKGROUND

Battery life longevity and the amount of charge a battery can hold can be negatively affected by various factors including the current at which a battery is charged and the time the battery spends at full charge. For instance, charging a battery at a relatively high current such as e.g. at an airport charging station can adversely affect the chemistry of the battery even if a relatively fast charging time is desirable in such an instance.

### SUMMARY

Accordingly, in a first aspect a device includes a battery charger, a processor, and a memory accessible to the processor. The memory bears instructions executable by the processor to access a history of at least one previous battery charge by the battery charger of a battery powering the device, access calendar information of a user of the device, determine an approximate time available to charge the battery based on the history, the calendar information, and a current charge level of the battery, and regulate current from the battery charger to the battery to charge the battery to a predetermined capacity to within at least a threshold time of the approximate time available.

In some embodiments, the current may be regulated by increasing or decreasing the current from the battery charger to the battery. The current may be increased or decreased at least in part using a circuit in the battery charger. Also in some embodiments, the current may be regulated to charge the battery continuously until the predetermined capacity to within the threshold time.

Furthermore, if desired the instructions may be executable by the processor to regulate current from the battery to at least one component of the device other than the battery charger. The instructions may also be executable by the processor to determine the approximate time available based at least in part on a determination that an event indicated in the calendar information is upcoming and that the battery will not be available for charging during the event. Additionally, the instructions may be executable by the processor to determine the approximate time based at least in part on an estimation of the time to charge the battery to full capacity from the current charge level of the battery, where full capacity is the predetermined capacity.

The instructions may be further executable by the processor to determine the approximate time available based on the history at least in part based on a determination that the battery was previously not available for charging at a particular time of day and/or a particular day of the week. The history of at least one previous battery charge by the battery charger may pertain to at least one previous battery charge of the battery.

In another aspect, a method includes initiating charging of a battery, determining a time available to charge the battery, and increasing or decreasing current to the battery from an initial current based at least partially on the time available, where the initial current is used at the initiating of the charging of the battery.

In still another aspect, a system includes an information handling system to be powered and a battery charger for charging at least one battery that powers the information handling system. The information handling system includes a processor and a memory accessible to the processor that bears instructions executable by the processor to access information to determine a current time available for charging the battery from its current charge level to a fully charged level, determine the current time available for charging the battery from its current charge level to the fully charged level at least partially based on the information, modulate current from the battery charger to the battery to charge the battery to a threshold charge amount below the fully charged level prior to a threshold time before the end of the current time available for charging the battery, and modulate current from the battery charger to the battery to charge the battery to the fully charged level after the threshold time.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system including a battery charger and battery in accordance with present principles;

FIGS. 2A-5 are exemplary flowcharts of logic to be executed by a system in accordance with present principles; and

FIG. 6 is an exemplary user interface (UI) presentable on a system in accordance with present principles.

### DETAILED DESCRIPTION

This disclosure relates generally to device based user information. With respect to any computer systems discussed herein, a system may include server and client components, connected over a network such that data may be exchanged between the client and server components. The client components may include one or more computing devices including, computers such as laptops, and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term“circuit” or“circuitry” is used in the summary, description, and/or claims. As is well known in the art, the term“circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

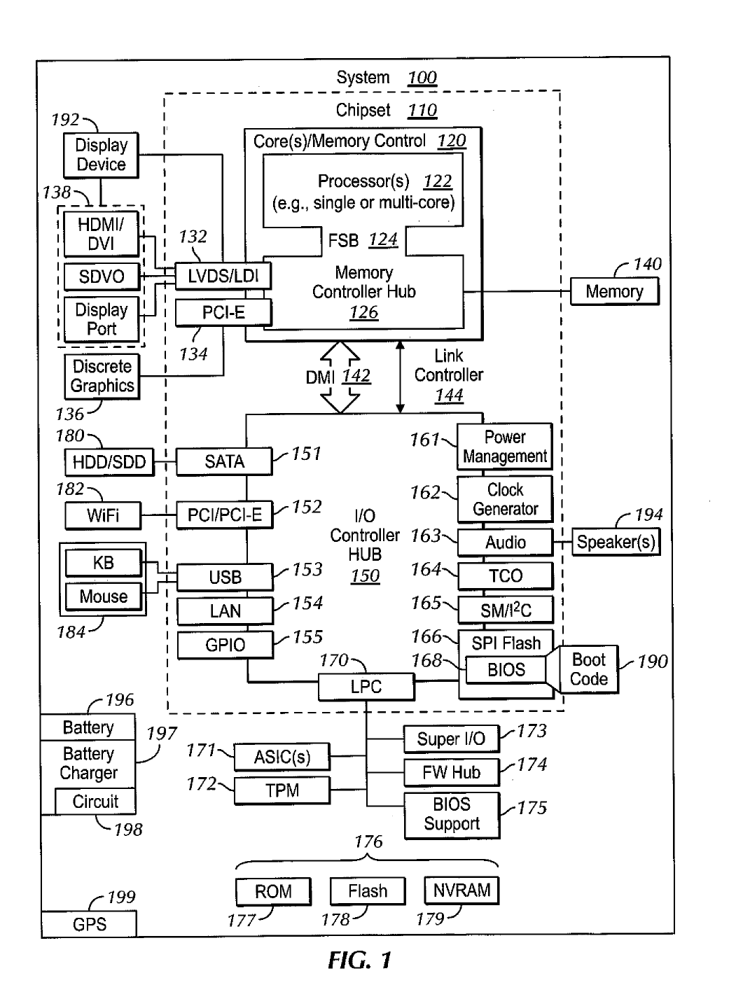

Now specifically in reference to FIG. 1, it shows an exemplary block diagram of an information handling system and/or computer system 100 such as e.g. an Internet enabled, computerized telephone (e.g. a smart phone), a tablet computer, a notebook or an Internet enabled computerized wearable device such as a smart watch, etc. Thus, in some embodiments the system 100 may be a ThinkPad® series of personal computers sold by Lenovo (US) Inc. of Morrisville, N.C.; however, as apparent from the description herein, a client device, such as a tablet may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an 110 controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 is understood to include a battery 196 connectable to e.g. an (e.g. AC) power supply (now shown for clarity) to provide power the system 100 and/or charge the battery 196 through a battery charger 197 (e.g. the battery provides power to system. The power supply charges battery and/or provides power if the battery is totally dead.). The battery charger 197 may include a circuit 198 for regulating and/or modulating current to the battery 196 to charge the battery 196. The circuit 198 may regulate and/or modulate current by e.g. increasing or decreasing current to the battery 196.

Also note that a GPS transceiver 199 is shown that is configured to e.g. receive geographic position information from at least one satellite and provide the information to the processor 122. However, it is to be understood that another suitable position receiver other than a GPS receiver may be used in accordance with present principles to e.g. determine the location of the system 100 such as e.g. determining location using WiFi fingerprint location techniques.

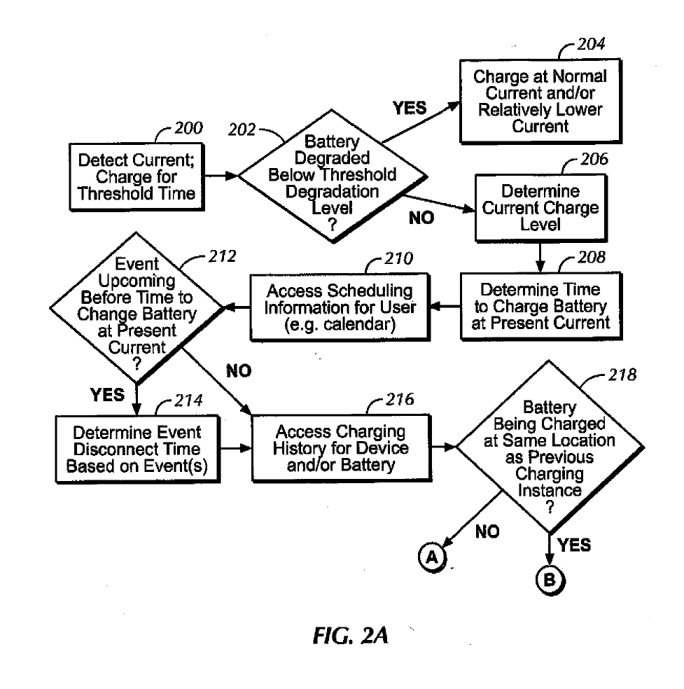

Before moving on to FIGS. 2A and 2B, it is to be understood that an exemplary client device or other machine/computer may include fewer or more features than shown on the system 100 of FIG. 1. In any case, it is to be understood at least based on the foregoing that the system 100 is configured to undertake present principles.

Now in reference to FIGS. 2A and 2B, an example flowchart of logic to be executed by a device such as the system 100 described above in accordance with present principles is shown. Beginning at block 200, the logic detects current being provided from a battery charger such as the charger 197, and may even e.g. charge the battery for a threshold time at the current being provided. E.g., this may be done to “warm up” the battery during charging before increasing the current in accordance with present principles so as to not cause a battery malfunction and/or battery damage during charging. In any case, from block 200 the logic proceeds to decision diamond 202 where the logic determines whether the battery has degraded below a threshold (e.g. lifetime and/or permanent) degradation level. For instance, should a battery be relatively old and degraded, even in instances where charging with a greater current may be generally desirable, doing so to a degraded battery may worsen and/or accelerate the degradation of the battery, shortening the battery's life even further and/or causing it to malfunction. Thus, if an affirmative determination is made at decision diamond 202, the logic proceeds to block 204 where the logic charges the battery at its default and/or regular current amount, and/or may even e.g. charge the battery at a relatively lower current than the default and/or regular current amount.

However, a negative determination at diamond 202 causes the logic to instead proceed to block 206 where the logic determines the current charge and/or power level of the battery. This may be e.g. a percentage of full charge that the battery is currently at (e.g. eighty eight percent, meaning the battery is charged to eighty eight percent of its full capacity). The logic then proceeds to block 208 where the logic determines a time to charge the battery at the present current (e.g. the default and/or regular current amount). This may be done by e.g. determining the number of percentage points the battery is from a predetermined charge such as e.g. fully charged (e.g. in one example, twelve points away), determining the time to charge the battery one percentage point (e.g. by tracking how long it takes to charge the battery one percentage point), and multiplying the time to charge the battery one percentage point by the number of percentage points the battery is from fully charged to thus render the time to fully charge the battery at the present current.

After block 208, the logic proceeds to block 210 where the logic accesses scheduling information pertaining to at least one user of the device being powered by the battery. For instance, the logic may access one or more electronic calendars it has been configured to access (e.g. provided with location information and rights permissions to access) such as e.g. an online calendar, a personal digital assistant calendar, a calendar application on the device powered by the battery and/or another device, a calendar for a group of people with which the user is associated, etc. After block 210, the logic proceeds to decision diamond 212 where the logic determines whether an event indicated in the scheduling information (e.g. in one or more of calendars that have been accessed) is upcoming (e.g. scheduled to begin) prior to the end of the time determined at block 208.

If an affirmative determination is made at decision diamond 212, the logic proceeds to block 214 where the logic determines a disconnect time (e.g. when the battery and/or battery charger are likely to be disconnected from a charging source such as a wall outlet in a personal residence) based on the events. The disconnect time may be e.g. user defined. Moreover, the disconnect time may be e.g. a predetermined threshold time for before the event is to occur to e.g. give the person time to disconnect the battery and/or charger from the charging source and travel to the event (e.g. in instances where the battery is not being charged at the location of the event). Thus, for instance, the user may have preset battery charging settings to charge the battery to fully charged at least e.g. ten minutes before any scheduled event, particularly when e.g. the logic determines that the current location of the battery and/or device powered by the battery is not at and/or proximate to the location for the event and hence is to be disconnected from its current power source prior to the event (e.g. where the event location may be indicated (e.g. in GPS coordinates, and/or the event has an associated address that may be queried on web or database GPS coordinates for that address) in the user's calendar) based on e.g. GPS coordinates from a GPS receiver/transmitter such as the GPS receiver 199 discussed above.

In any case, note that a negative determination at diamond 212 causes the logic to proceed directly to block 216 instead of block 214, it being also noted that from block 214 the logic proceeds to block 216. But regardless of which way the logic arrives at block 216, thereat the logic accesses a charging history for the device and/or for the particular battery being charged. The charging history may include information such as information pertaining to at least one previous charge instance of the battery (and/or charging instances for another battery and/or another device that is or are associated with a user, where such charging instances may be stored in and accessed in e.g. a cloud storage area of the user). Thus, examples of information that may be included in the charging history include a duration during which the device and/or battery was at a particular location even if not e.g. charged and/or connected to a power source such as a wall outlet for the entire duration, a duration during which the device and/or battery was at a location of the same type or category as a current location (e.g. the user on average spends a particular amount of time at coffee shops and the device is currently at a coffee shop even if e.g. not a coffee shop previously visited with the device), a previous total time to charge the battery and/or that the battery was actually charged, a temporal value for a charge increment in accordance with present principles for previously charging the battery, an average of previous times to charge the battery and/or an average of previous temporal values for a charge increment in different charging instances, the time(s) of day the battery was previously charged, the day(s) of the week the battery was previously charged, the day(s) of the month the battery was previously charged, the day(s) and/or particular dates of year the battery was previously charged, etc. Also note that the charging history may include location information including e.g. one or more locations at which the battery was charged as determined e.g. based on GPS coordinates from a GPS receiver of the device such as the GPS transmitter/receiver 199 discussed above. Furthermore, note that the various types of time information discussed above (e.g. previous total time to charge the battery) may be (e.g. respectively) associated with various (e.g. different) locations. Thus, for instance, two previous charging instances as indicated in the charging history may be associated with a first location such as a personal residence, and two additional charging instances as indicated in the charging history may be associated with a second location such as an office. In any case, it is to be understood that the charging history information may be useful to e.g. determine previous instances when the battery was unavailable for charging to predict when the battery may not be available for charging in the future in accordance with present principles. For instance, if the charging history indicates that a battery has been removed from a charging power source (e.g. a wall socket) at the user's office at five o'clock every or at least some afternoons, the logic may determine that a current charging instance of the battery should be completed before five o'clock in the afternoon when the device is located at the office.

Accordingly, after block 216 the logic proceeds to decision diamond 218 where the logic determines whether the battery is being currently charged at the same location as a previous charging instance (e.g. indicated in the charging history). If a negative determination is made at decision diamond 218, the logic proceeds to block 220. At block 220 e.g. when the logic has made an affirmative determination at diamond 212, the logic regulates and/or modulates current to the battery (e.g. by increasing or decreasing the current relative to the present current and/or default current) to charge the battery (e.g. continuously) to at least a threshold time before the disconnect time determined at block 214. E.g., this threshold time may be the predetermined threshold time for before the event is to occur discussed above in reference to block 214. However, at block 220 e.g. when the logic has made a negative determination at diamond 212 (e.g. no event is determined to be upcoming before the time to charge the battery to fully charged at the present current as discussed above), the logic regulates and/or modulates current to the battery (e.g. by increasing or decreasing the current in accordance with present principles) to charge the battery (e.g. continuously) at the present and/or default current.

Now referring back to decision diamond 218, if instead of a negative determination the logic makes an affirmative determination thereat, the logic proceeds to block 222. At block 222, the logic determines and/or accesses a history and/or history information such as the information discussed above (e.g. times of day during which the battery was previously charged) that is associated with the particular location (e.g. previous charging instances at that location) at which the device is currently at, around, and/or proximate to. Also at block 222, the logic determines in accordance with present principles a potential disconnect time based on the history and/or history information for the particular location (e.g. as discussed above, the logic determines that the user on Monday through Friday disconnects the battery from a wall outlet at five o'clock in the afternoon, and thus the device may potentially be disconnected in the present instance (e.g. a Tuesday) at five o'clock).

From block 222 the logic proceeds to decision diamond 224 where the logic determines whether the potential disconnect time is less than the time to charge the battery at the present and/or default current, and/or whether the potential disconnect time is less than the event disconnect time (e.g. determined at block 214) is applicable (e.g. if an affirmative determination was made at diamond 212). An affirmative determination at diamond 224 causes the logic to proceed to block 226 where the logic regulates and/or modulates current to the battery (e.g. by increasing or decreasing the current in accordance with present principles) to charge the battery (e.g. continuously) to a fully charged level at or before a threshold time, where the threshold time is a time prior to the potential disconnect time. Note, however, that in some embodiments the logic may regulate and/or modulate current to the battery to charge the battery to a fully charged level at the potential disconnect time rather than the threshold time before, if desired.

In any case, from block 226 the logic proceeds to block 228, it being noted that from block 220 the logic also proceeds to block 228. Regardless, at block 228 and if desired (e.g. based on user settings, predefined settings, in order to charge to fully charge the battery by the time at which it is to be fully charged, etc.), the logic may reduce power supplied by the battery and/or charging source to other components of the device being powered by the battery and/or charging source, such as e.g. reducing power to one or more processors, a network interface card, a graphics card, disabling discrete graphics, etc. Note that in some embodiments, power may be reduced for a predetermined time, may be cycled such that it may be reduced for a predetermined time, increased again for a predetermined time (e.g. power to a network interface card may be temporarily increased to send a keep alive packet), decreased again, etc. Note further that in some embodiments power to one or more components may be reduced until the battery reaches a threshold charge level that may be predetermined and/or user determined, at which point power may be increased again to the component(s) for the remainder of the charging of the battery to fully charged.

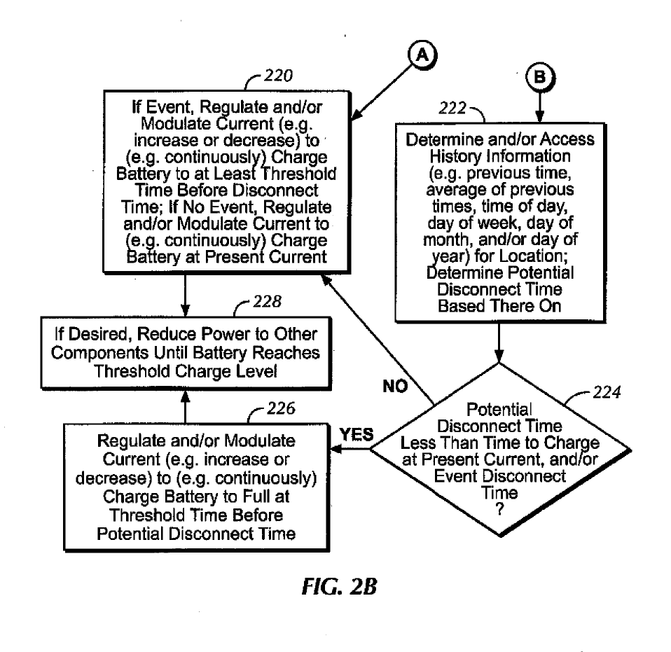

Before moving on to FIG. 3, it is to be understood that the current regulation and/or modulation in accordance with present principles (e.g. increasing or decreasing the current) may be done by controlling a circuit in the battery charger regulating current, such as e.g. the circuit 198 discussed above. Also note that although in some embodiments current may be continuously provided during battery charging (e.g. at a continuous current (e.g. after being increased and/or decreased)), current regulation and/or modulation may include ceasing to charge the battery for an amount of time and then resuming to charge the battery again.

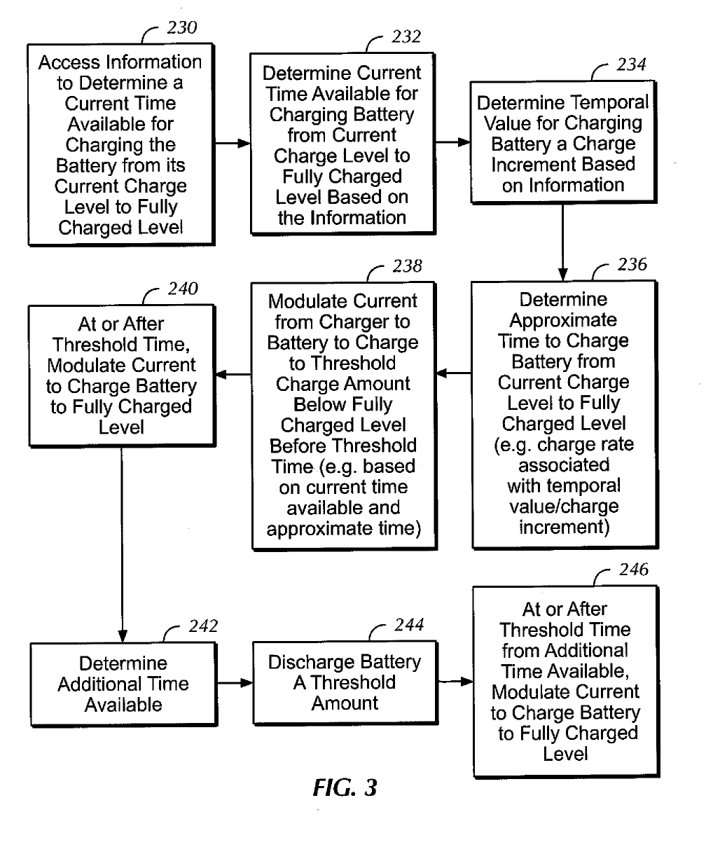

Now in reference to FIG. 3, it is to be understood that it may be undertaken in conjunction with the logic of FIG. 2 in some embodiments, and/or may be separately executed by a processor in accordance with present principles. Regardless, FIG. 3 begins at block 230 where the logic accesses information (e.g. event information) to determine a current time available for charging a battery from its current charge level to fully charged in accordance with present principles. The logic then proceeds to block 232 where the logic determines the current time available for charging the battery from its current charge level to fully charged at least partially based on the information in accordance with present principles. Thereafter, the logic moves to block 234 where the logic determines a temporal value for charging the battery a charge increment based on the information in accordance with present principles. Determining the temporal value will be discussed further in reference to FIG. 4.

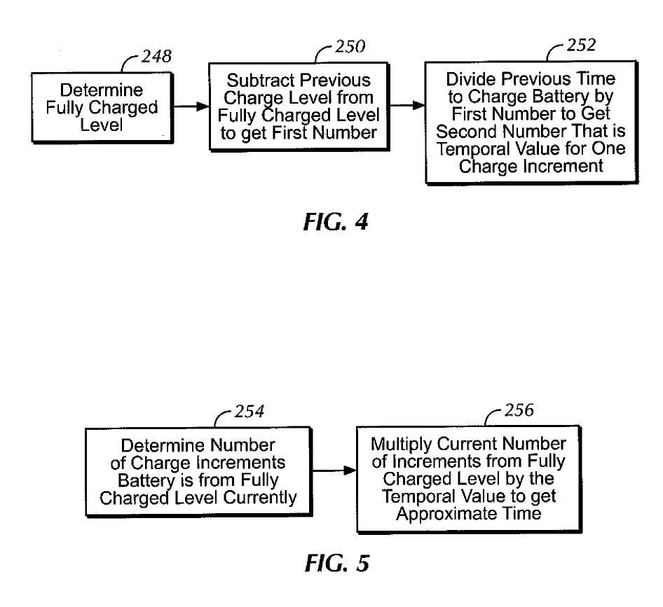

Still in reference to FIG. 3, the logic proceeds from block 234 to block 236 where the logic determines an approximate time to charge the battery from its current charge level to fully charged (e.g. at least in part based on the temporal value) in accordance with present principles based on e.g. a charge rate associated with the temporal value and/or charge increment (e.g. as indicated in history information e.g. for the particular location at which the battery is currently disposed). Determining the approximate time to charge the battery from its current charge level to fully charged will be discussed further in reference to FIG. 5. After block 236, the logic proceeds to block 238 where the logic modulates current from the battery charger to the battery to charge the battery to a threshold charge amount below a fully charged level prior to a threshold time e.g. based at least partially on one or both of the current time available and/or the approximate time. Thus, the threshold time may be a time before the end of the current time available for charging the battery and/or a time before the approximate time.

Furthermore, note that e.g. should the current time available be less than the approximate time, the threshold time to charge the battery the threshold charge amount may be before the current time available, and hence at block 238 the logic may modulate the current by e.g. increasing it beyond the charge rate associated with the temporal value and/or charge increment. However, note that in some embodiments, when the approximate time is less than the current time available, the threshold time to charge the battery the threshold charge amount may be before the approximate time, and hence the logic may modulate the current by e.g. providing current at the charge rate associated with the temporal value and/or charge increment, and/or a lesser rate that nonetheless charges the battery to the threshold amount before the threshold time (e.g. and still before the current time available).

Continuing the description of FIG. 3, the logic proceeds from block 238 to block 240 where the logic, at or after the threshold time to charge the battery the threshold charge amount, modulates current from the battery charger to the battery to charge the battery to its fully charged level. The logic may end at block 240, or may optionally proceed to block 242. At block 242, the logic determines whether additional time is available during which e.g. the device will be at or proximate to the current location and/or whether additional time is available for charging. For instance, at block 242 the logic may determine that there was an event indicated in the user's calendar that is associated with a location different form the current location, but that the device has remained in the current location beyond the start time of the event (e.g. it may be determined that the user is not adhering to the calendar by not attending the event).

Accordingly, from block 242 the logic after charging the battery to fully charged (e.g. at block 240) prior to conclusion of this additional time available may at block 244 discharge the battery (e.g. distribute power to other system components to discharge the battery to a level below the fully charged level) a threshold amount that may be e.g. user determined and/or predetermined. The logic may then proceed to block 246 where the logic, at or after a threshold time before the conclusion of the additional time available, modulates current to the battery to charge it back to the fully charged level.

Continuing the detailed description in reference to FIG. 4, it shows logic for determining the temporal value referenced above. Beginning at block 248, the logic determines a fully charged level for the battery in accordance with present principles. Note that the fully charged level for the battery may vary during the life of the battery. E.g. an old battery may be charged as much as possible to a current maximum charge capacity, even if that maximum charge capacity is now less than it may have been when the battery was newer. Regardless, after block 248 the logic takes the fully charged level and subtracts a previous charge level (e.g. as indicated in history information in accordance with present principles) therefrom to render a first number. Then at block 252 the logic divides a previous time to charge the battery (e.g. as indicated in history information in accordance with present principles) by the first number to render a second number that is the temporal value for one charge increment.

As an example, suppose that one hundred percent is the fully charged level. Also suppose the previous charge level was eighty percent, and that it previously took twenty five minutes to charge the battery from eighty percent to one hundred percent (e.g. at that location). Eighty would be subtracted from one hundred to render the number twenty (the first number in this instance), which corresponds to the twenty percent difference between one hundred percent and eighty percent. Twenty five (the minutes taken to charge the battery from eighty to one hundred percent) is then divided by twenty (the difference between eighty percent and one hundred percent) to render the number one and one quarter, which is the temporal value in minutes for the time it previously took to charge the battery one percentage point.

Notwithstanding, note that the foregoing assumes a more or less linear charging rate, which may not always be the case. E.g., when charging from zero to twenty percent and from eighty to one hundred percent, charging within those increments may take longer than charging for the same battery e.g. from twenty to eighty percent. Accordingly, different increments may be determined for different portions of the charging percentages of the battery and then added to render a total (e.g. estimated and/or proximate) charging time in accordance with present principles. For instance, if the battery is at seventy eight percent capacity when charging is initiated, and from twenty to eighty percent the battery charges at two minutes per percent, but above eighty percent charges at three minutes per percent, it may be determined that it will take approximately sixty four minutes to charge the battery from seventy eight percent capacity to one hundred percent capacity in accordance with present principles.

Now in reference to FIG. 5, it shows exemplary logic for determining the approximate (e.g. total) time to charge the battery from its current charge level to fully charged based on a temporal value (e.g. such as the one as determined in reference to FIG. 4) in accordance with present principles. The logic of FIG. 5 begins at block 254 where the logic determines a current number of charge increments the battery is from the fully charged level (e.g. a current number of percentage points). Then at block 256 the logic multiplies the current number of charge increments the battery is from the fully charged level by the temporal value to render a time to charge the battery at the same rate as associated with the temporal value and/or charge increment. Note that the “approximate” time that is determined may be an approximate time in the respect that e.g. currently available current for charging the battery may not necessarily be precisely the same as the previous current for the temporal value and hence the charging time based on the charge increment may not necessarily be precisely the same as it would if the present current were the same as during the previous charge instance.

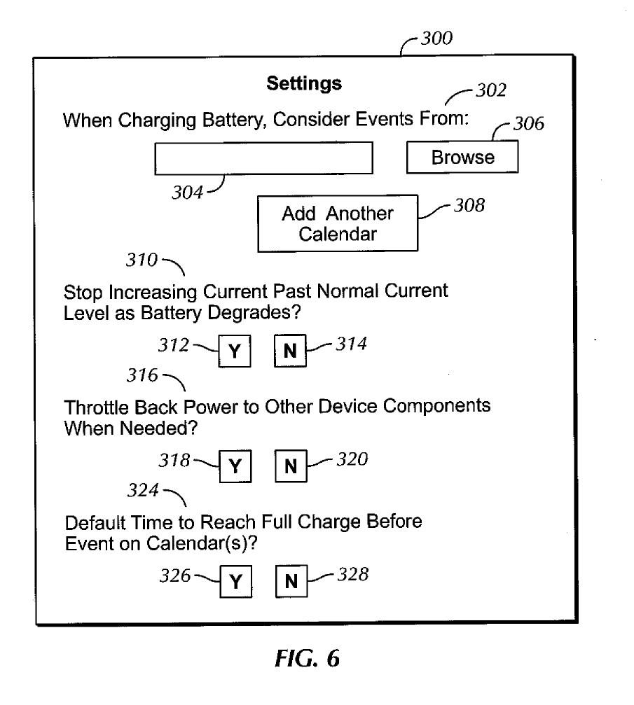

Now in reference to FIG. 6, it shows an exemplary user interface (UI) presentable on a device being powered by a battery in accordance with present principles. Thus, a UI 300 is shown for configuring settings associated with the charging of the battery. The UI 300 includes a first setting 302 for providing information on one or more e.g. calendars for the device to access when determining upcoming events in accordance with present principles. An input box 304 is thus shown for such purposes, as is a browse selector element 306 selectable to e.g. automatically without further user input cause a window to be overlaid on the UI 300 for browsing to e.g. a location of calendar information that is local on a computer readable storage medium of the device to thus select the location and hence provide access to the information for use in accordance with present principles. An add calendar selector element 308 is also shown for causing e.g. additional input boxes (e.g. similar to the box 304) and browse selector elements (e.g. similar to the element 306) to be presented for configuring the device to access more than one source of event information when undertaking present principles.

The UI 300 also includes a second setting 310 for whether to stop and/or cease increasing current (e.g. by modulating and/or regulating) past a normal and/or default charge rate/level as the battery degrades (e.g. beyond a threshold point and/or amount). Thus, a yes selector element 312 and no selector element 314 are presented for selecting respectively whether to stop increasing current or to continue to increasing current in accordance with present principles even when the battery is degraded e.g. beyond a certain point.

Yet another setting 316 is shown for whether to reduce (e.g. throttle back) power to other device components while charging the battery (e.g. when needed, possible, and/or applicable) in accordance with present principles. A yes selector element 318 is thus presented and is selectable to configure the device to do so, and a no selector element 320 is also shown for to configure the device to not reduce power to other components of the device.

The UI 300 also includes a setting 324 for a user to provide input for a default and/or threshold time for the battery to reach fully charged prior to one or more events that may be upcoming. Thus, an input box 326 for inputting a number is shown, along with an element 328 for selecting a time increment to be associated with the number (e.g. seconds, minutes, hours, etc.). Thus, in the present exemplary instance shown, a user has input the number twenty into the box 326 and selected minutes as the time increment, thus providing input to the device to establish the default and/or threshold time at twenty minutes prior to an event indicated in calendar information.

Without reference to any particular figure, it is to be understood that present principles apply to an intelligent battery charger and/or device which tracks usage of the device and the charging and habits of the user. This tracking may include use dates, use times, and elapsed usage time, as well as charge dates, charge times, and elapsed charging times. Parameters regarding the specific battery being charged may also be known to and/or determined by the intelligent battery charger. This information may be utilized to develop a device usage and charging profile for a particular battery and/or the device in which the battery is used, to then undertake charging based on the profile(s).

Furthermore, as understood herein and referenced above, a battery may be charged via a battery charger coupled to e.g. an AC power source via AC adaptor. A processor undertaking present principles may be configured to monitor the conditions of battery, the operation of charger, and the operation of device hardware, and then store the results of this monitoring operation in a memory of the device. Thus, the processor may have access to statistical information regarding the battery such as e.g. its current capacity, the number of charging cycles it has been through, deep cycle charge history, battery serial number, battery thermal condition, and battery type, etc. to undertake present principles. The processor may also have access to data regarding the operation of the battery charger, such as the duration of any charging, the times that the charging occurs, the charging levels used, etc. to undertake present principles. What's more, with respect to device hardware other than e.g. the charger, the processor may have access to statistical information regarding the timing and dates of operation of the device, the duration of operation, the amount of current drawn by the device hardware during these operations, etc. to undertake present principles.

It is also be understood that data regarding the particular battery in the device can be stored in the device's memory so that varying charging parameters e.g. based on the type of battery can be taken into account when the processor charges the battery in accordance with present principles. In addition, the serial number of the battery may be be used as a unique identifier to capture and store battery history for different batteries. This information may come from various sources, including e.g. manual input from the user, data received from the battery manufacturer via a network connection such as the Internet, data stored in a memory integrated into the battery itself (e.g., a “smart battery”), etc.

Present principles also recognize that e.g. based on information as discussed herein such as history information and event information, a device in accordance with present principles even when engaged with a power supply may nonetheless delay charging the battery until a particular time of day, or until certain values (e.g. increments) of charge in the battery are reduced to a certain level, etc.

Present principles also recognize that a device in accordance with present principles may maintain a history of battery usage and charges, determine the tolerances of the actual battery relative to capacity, age of battery, and current (e.g. battery) temperature used based on present battery information that is e.g. obtained by directly communicating with the battery via a communications channel. The device may also have access to e.g. information on how to optimally use the battery based upon e.g. a manufacturer's suggestion that is accessible to the device (e.g. gathered from the battery directly, input by a user, and/or as determined from the manufacturer information located on the Internet).

What's more, present principles recognize that values and/or estimates for the amount of charge for the battery (e.g. such as the percentages described herein) may be provided by the battery itself, based on e.g. a detailed and non-linear model stored in a battery controller of the battery, based on the current charge level, and/or the current being drawn or supplied.

Based on the foregoing, it may be appreciated that the negative impacts on battery chemistry when charging a battery may be lessened, thus increasing the battery's longevity. It may also be appreciated that determining that the battery may only have a limited amount of time to charge in a particular instance may be used to thus charge the battery as quickly as possible so that the battery can be fully charged (or as close as possible) prior to the potential charge disconnect time.

This may be done e.g. based on the observed usage pattern for the device and/or battery being charged to thus estimate when an AC adapter will be available for charging a battery for a relatively long period of time, or relatively a short period of time, as well as when the observed usage pattern may not apply (e.g., the device is at and/or being used in a location that is outside of the normal usage pattern and/or for which history information cannot be accessed). To do so, the locations and times when the AC adapter is attached may be monitored by the device, and/or information may be integrated from the user's calendar for such purposes. Present principles also apply for charging when e.g. it is predicted that the device may be in and/or about to enter a sleep mode, may hibernate, and/or may be powered off, which can be combined with AC adapter model information for similar battery management tasks.

In instances where the device determines that the AC adapter will be attached for a relatively long period of time, the battery may be managed by the device (e.g. to preserve battery longevity) in one or more of the following ways: Charge the battery with a smaller current (e.g. while still causing the battery to be fully charged by the time the user will remove the AC adapter), charge the battery most of the way to capacity (e.g. to 80 percent or 90 percent) at a normal charge rate and/or current, and then “top it off” (e.g. to 100 percent) with additional charge when it is predicted that the AC adapter will be removed shortly (e.g., with 30 minutes to spare to thus provide some additional battery charge in the event that the prediction is not entirely accurate), and/or when the battery is fully charged the battery may be discharged partially (e.g. to 80 percent or 90 percent) and then charged back to full shortly before the time predicted at which the AC adapter will be removed.

In instances where the device determines that the AC adapter will be attached for a relatively short period of time, the battery may be managed by the device (e.g. to preserve battery longevity) in one or more of the following ways: Charging with a relatively higher current which charges the battery more rapidly (e.g. as may be preferable in some circumstances) where e.g. the charging at the relatively higher current may be managed by the device so that the relatively rapid charge is performed e.g. only occasionally (e.g. only a predetermined number of times within a predetermined period), and/or throttling other components of the device so that more of the power from the AC adapter and/or system power circuitry is available to charge the battery (e.g., CPU throttling, disabling discrete graphics, etc.).

Furthermore, the foregoing may be taken in accordance with the current health of the battery. For instance, a relatively less degraded battery may be “stricter” with the prediction criteria in that it may charge at relatively higher current without weighting the state of the battery as much as other factors such as e.g. an upcoming event and history information. Conversely, a relatively more degraded battery may be managed to charge with a relatively smaller current while also weighting the state of the battery relatively higher and/or more than other factors such as e.g. an upcoming event and history information.

What's more, it is to be understood that the foregoing actions may be taken in accordance with information from a battery cell vendor of the battery being charged. E.g., some battery cells do not undergo as much appreciable longevity improvement when charged at a relatively smaller charge rate and hence charging at a relatively higher charge rate may be relatively more preferable even through time as the battery continues to be used.

While the particular SYSTEMS AND METHODS TO INCREASE AND DECREASE CHARGING CURRENT TO BATTERY is herein shown and described in detail, it is to be understood that the subject matter which is encompassed by the present application is limited only by the claims.

What is claimed is:

1. A device comprising:
a battery charger;
a processor;
a memory accessible to the processor and bearing instructions executable by the processor to:
access a history of at least one previous battery charge by the battery charger;
access calendar information associated with a user of the device;
based on the history, the calendar information, and a current charge level of a battery to be charged by the battery charger, determine an approximate time available to charge the battery, wherein the battery provides power to the device; and
regulate current from the battery charger to the battery to charge the battery to a predetermined capacity to within at least a threshold time of the approximate time available.

2. The device of claim 1, wherein the current is regulated to charge the battery continuously until the predetermined capacity to within the threshold time.

3. The device of claim 1, wherein the instructions are executable by the processor to regulate current from the battery to at least one component of the device other than the battery charger.

4. The device of claim 1, wherein the instructions are executable by the processor to determine the approximate time available based at least in part on a determination that an event indicated in the calendar information is upcoming and that the battery will not be available for charging during the event.

5. The device of claim 1, wherein the instructions are executable by the processor to determine the approximate time available based on the history at least in part based on a determination that the battery was previously not available for charging at a particular time of day.

6. The device of claim 1, wherein the instructions are executable by the processor to determine the approximate time available based on the history at least in part based on a determination that the battery was previously not available for charging at a particular time of day on a particular day of the week.

7. The device of claim 1, wherein the predetermined capacity is a full capacity of the battery, and wherein the instructions are executable by the processor to determine the approximate time based at least in part on an estimation of the time to charge the battery to the full capacity from the current charge level of the battery.

8. The device of claim 1, wherein the current is regulated by increasing or decreasing the current from the battery charger to the battery.

9. The device of claim 8, wherein the current is increased or decreased at least in part using a circuit in the battery charger.

10. The device of claim 1, wherein the history of at least one previous battery charge by the battery charger pertains to at least one previous battery charge of the battery.

11. A method, comprising:
initiating charging of a battery;
determining a time available to charge the battery; and
based at least partially on the time available, increasing or decreasing current to the battery from an initial current, the initial current being used at the initiating of the charging of the battery.

12. The method of claim 11, wherein the current is increased or decreased at least in part using a circuit in a battery charger, and wherein the battery charger charges the battery.

13. The method of claim 11, wherein the initiating charging of the battery includes charging the battery at the initial current for a threshold time.

14. The method of claim 11, wherein the determining a time available to charge the battery is based on information selected from the group consisting of: calendar information from a calendar of a user of a device, and a history of previous charges of the battery.

15. The method of claim 11, further comprising:
based on the time available, reducing power from the battery to at least one component of a device powered by the battery, the reducing being for at least until the battery charges to a threshold level, the component not being a battery charger charging the battery.

16. The method of claim 11, further comprising:
charging the battery at the increased or decreased current until the battery is fully charged, the battery being charged to fully charged prior to the conclusion of the time available;
discharging the battery a threshold amount; and
at a threshold time before the conclusion of the time available, charging the battery until the battery is fully charged.

17. A system, comprising:
an information handling system to be powered; and
a battery charger for charging at least one battery, wherein the battery powers the information handling system;
wherein the information handling system includes:
a processor;
a memory accessible to the processor and bearing instructions executable by the processor to:
access information to determine a current time available for charging the battery from its current charge level to a fully charged level;
determine the current time available for charging the battery from its current charge level to the fully charged level at least partially based on the information;
modulate current from the battery charger to the battery to charge the battery to a threshold charge amount below the fully charged level prior to a threshold time, the threshold time being a time before the end of the current time available for charging the battery; and
modulate current from the battery charger to the battery to charge the battery to the fully charged level after the threshold time.

18. The system of claim 17, wherein the information includes history information for at least one previous charging instance of the battery, wherein the history information includes a duration at which the information handling system was previously at a particular location.

19. The system of claim 18, wherein the instructions are executable by the processor to determine the current time available for charging the battery from its current charge level to the fully charged level at least in part based on the information handling system being proximate to the location.

20. The system of claim 17, wherein the information includes history information for at least one previous charging instance of the battery, wherein the history information includes a previous time to charge the battery from a previous charge level to the fully charged level; and
wherein the instructions are executable by the processor to:
determine a temporal value for charging the battery a charge increment based on the history information, wherein the temporal value is determined by taking the fully charged level and subtracting the previous charge level therefrom to render a first number, and dividing the previous time to charge the battery by the first number to render a second number, wherein the second number is the temporal value; and
determine an approximate total time to charge the battery from its current charge level to the fully charged level by determining a current number of charge increments the battery is from the fully charged level and multiplying it by the temporal value, wherein current from the battery charger is modulated to charge the battery to the threshold charge amount based on the current time available and the approximate total time.
